(19) United States
(12) Patent Application Publication
(10) Pub. No.: US 2025/0263130 A1
(43) Pub. Date: Aug. 21, 2025

(54) VEHICLE LOWER PART STRUCTURE

(71) Applicant: TOYOTA JIDOSHA KABUSHIKI KAISHA, Toyota-shi (JP)

(72) Inventor: Katsuichiro HIRAKAWA, Toyota-shi (JP)

(73) Assignee: TOYOTA JIDOSHA KABUSHIKI KAISHA, Toyota-shi (JP)

(21) Appl. No.: 18/959,658

(22) Filed: Nov. 26, 2024

(30) Foreign Application Priority Data
Feb. 20, 2024 (JP) 2024-023743

(51) Int. Cl. B62D 25/20; B60R 19/24

(52) U.S. Cl. CPC B62D 25/2027; B60R 19/24

(57) ABSTRACT

A vehicle lower part structure includes a resin rear floor portion provided in a rear part of the vehicle and having a floor pan forming portion, and a resin undercover portion that forms a lower surface of the rear part of the vehicle and is molded integrally with a lower end of the rear floor portion.

### CROSS-REFERENCE TO RELATED APPLICATION

This application claims priority to Japanese Patent Application No. 2024-023743 filed on Feb. 20, 2024, incorporated herein by reference in its entirety.

### BACKGROUND

### 1. Technical Field

The present disclosure relates to vehicle lower part structures.

### 2. Description of Related Art

Japanese Unexamined Patent Application Publication No. 2018-122774 (JP 2018-122774 A) discloses a vehicle lower part structure intended to improve aerodynamic characteristics by an undercover.

### SUMMARY

A rear floor that is provided in the rear part of a vehicle has been manufactured as an iron component, while an undercover that forms the lower surface of the rear part of a vehicle is a resin product. That is, the rear floor and the undercover are manufactured as separate members. Therefore, conventional vehicle lower part structures have room for improvement in terms of reducing the number of parts.

The present disclosure provides a vehicle lower part structure that can reduce the number of parts.

A vehicle lower part structure of a first aspect includes:
a resin rear floor portion provided in a rear part of a vehicle and including a floor pan forming portion; and
a resin undercover portion that forms a lower surface of the rear part and that is molded integrally with the rear floor portion.

The vehicle lower part structure of the first aspect includes:
the resin rear floor portion provided in the rear part of the vehicle and including the floor pan forming portion; and
the resin undercover portion that forms the lower surface of the rear part of the vehicle and that is molded integrally with the rear floor portion.
   Therefore, the vehicle lower part structure of the first aspect can reduce the number of parts compared to a case where a member corresponding to the rear floor portion and a member corresponding to the undercover portion are configured as separate members. Since the resin rear floor portion has high design and manufacturing flexibility, it is easy to form the floor pan forming portion in such a shape that the floor pan forming portion is connected to the undercover portion.

According to a second aspect, in the vehicle lower part structure of the first aspect,
the floor pan forming portion may include a vertical wall portion that extends downward and whose lower end is connected to the undercover portion.

The floor pan forming portion of the vehicle lower part structure of the second aspect includes the vertical wall portion that extends downward and whose lower end is connected to the undercover portion. This allows the floor pan forming portion to be formed in a deep shape such that the floor pan forming portion is connected to the undercover portion.

According to a third aspect, the vehicle lower part structure of the first or second aspect may further include
a bumper cover that is provided in the rear part and whose front end is connected to a rear end of the undercover portion, and
a lower surface of the rear end of the undercover portion and a lower surface of the front end of the bumper cover may be flush with each other.

In the vehicle lower part structure of the third aspect, the lower surface of the rear end of the undercover portion and the lower surface of the front end of the bumper cover are flush with each other. The undercover portion and the bumper cover can therefore provide good aerodynamic characteristics.

As described above, the vehicle lower part structure according to the present disclosure is advantageous in that it can reduce the number of parts.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view of a resin unit, a cross member, and a rear side member of a vehicle lower part structure according to an embodiment;

FIG. 2 is a schematic cross-sectional view taken along line 2-2 of FIG. 1; and

FIG. 3 is a cross-sectional view similar to FIG. 2 of a variant.

### DETAILED DESCRIPTION OF EMBODIMENTS

Hereinafter, a vehicle lower part structure according to an embodiment will be described with reference to the accompanying drawings. The arrow UP, the arrow FR, and the arrow LH shown in the drawings respectively indicate an upper side in the vehicle up-down direction, a front side in the vehicle front-rear direction, and a left side in the vehicle left-right direction.

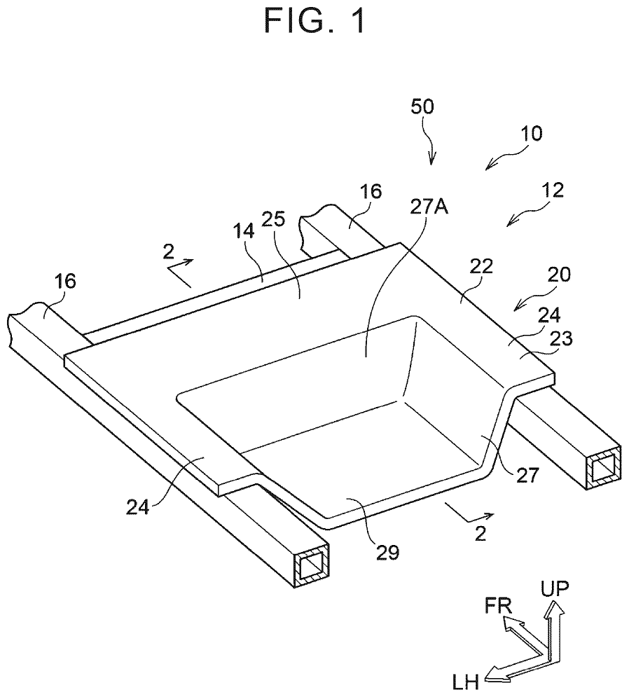

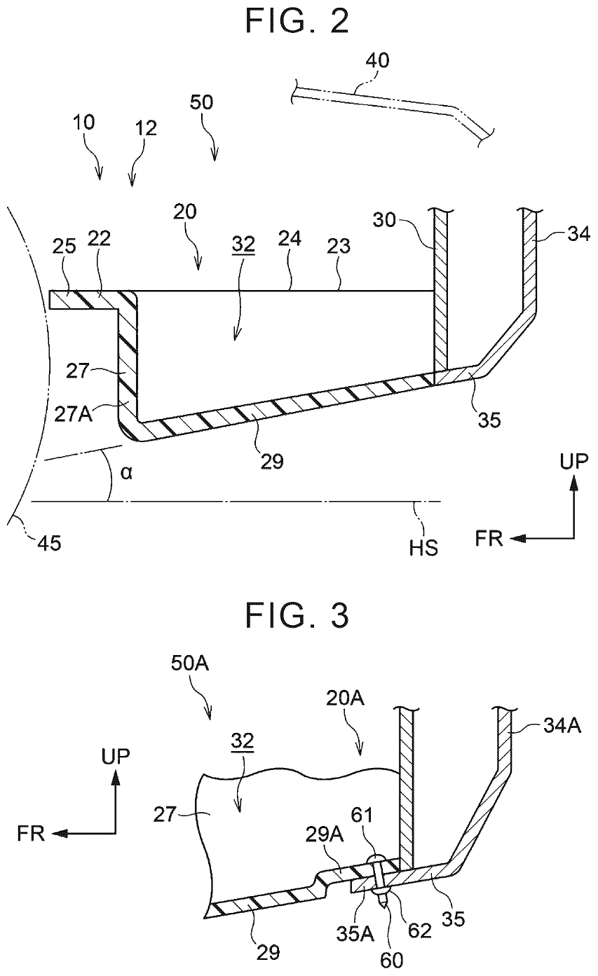

FIG. 1 and FIG. 2 show a rear part of a vehicle 10 to which the vehicle lower part structure of the present embodiment is applied. At the rear part of the vehicle body 12 of the vehicle 10, a cross member 14 which is a vehicle body skeleton member and extends in the vehicle width direction (left-right direction) and a pair of left-right rear side members 16 which are a vehicle body skeleton member and extend in the front-rear direction are provided. The left and right ends of the cross member 14 are connected to the left and right rear side members 16, respectively.

In a space located between the cross member 14 and the left and right rear side members 16, a resin unit 20 which is an integrally molded product made of resin is provided. The resin unit 20 includes a rear floor portion 22 and an undercover portion 29. The rear floor portion 22 includes a floor forming portion 23 having a flat plate shape and having a substantially U-shaped planar shape, and a floor pan forming portion 27 extending downward from an inner peripheral edge portion of the floor forming portion 23. The sectional shape of the floor pan forming portion 27 when cut in the horizontal plane is substantially U-shaped. The front wall portion (vertical wall portion) 27A of the floor pan forming portion 27 is a plate-shaped portion extending substantially vertically downward from the floor forming portion 23. Further, an outer peripheral portion of a flat plate-shaped undercover portion 29 having a substantially rectangular planar shape is connected to a peripheral edge portion of a lower end of the floor pan forming portion 27. As shown in FIG. 2, in a side view, the lower surface of the undercover portion 29 is inclined at an angle α° with respect to the horizontal plane HS. For example, α=8. As shown in FIG. 2, the undercover portion 29 constitutes the lower surface of the rear part of the vehicle body 12.

The left and right side portions 24 of the floor forming portion 23 are mounted on the upper surfaces of the left and right rear side members 16 and are fixed to the respective rear side members 16. Further, a front portion 25 of the floor forming portion 23 is mounted on the upper surface of the cross member 14 and fixed to each cross member 14.

As shown in FIG. 2, a rear back 30 is fixed to a rear end of the floor pan forming portion 27 and a rear end of the undercover portion 29. Further, the floor pan forming portion 27, the undercover portion 29, and the rear back 30 form a space 32 with an open top surface. A bumper (not shown) is fixed to a rear surface of the rear back 30. Further, a bumper cover 34 constituting a part of the rear end of the vehicle body 12 is fixed to a bracket (not shown) fixed to the rear back 30. As shown in FIG. 2, the front end (lower end) of the bumper cover 34 is constituted by an inclined portion 35 inclined with respect to the horizontal plane HS in a side view. Further, the front end of the inclined portion 35 is connected to the rear end of the undercover portion 29, and the front end of the inclined portion 35 and the rear end of the undercover portion 29 are fixed to each other. Further, the lower surface of the inclined portion 35 and the lower surface of the rear end of the undercover portion 29 are flush with each other.

As shown in FIG. 2, a back door 40 positioned directly above the resin unit 20 is provided in the rear part of the vehicle body 12 in such a manner that the back door 40 can be opened and closed. Therefore, when the back door 40 is in the open position, the resin unit 20 can be exposed to the outside of the vehicle. Further, when the vehicle 10 is viewed from the side, the left and right rear wheels 45 are positioned immediately in front of the resin unit 20.

In the above-described configuration, the resin unit 20, the rear back 30, and the bumper cover 34 are components of the vehicle lower part structure 50.

### Action and Effect

Next, operations and effects of the present embodiment will be described.

The vehicle lower part structure 50 described above includes the resin unit 20 having the rear floor portion 22 and the undercover portion 29. The rear floor portion 22 is supported by a rear side member 16 provided in the rear part of the vehicle body 12 of the vehicle 10. The undercover portion 29 constitutes the lower surface of the rear part of the vehicle body 12, and is molded integrally with the rear floor portion 22. Therefore, in the vehicle lower part structure 50, the number of parts can be reduced as compared with a case where a member corresponding to the rear floor portion 22 and a member corresponding to the undercover portion 29 are configured as separate members.

Furthermore, a space 32 is formed by the floor pan forming portion 27, the undercover portion 29, and the rear back 30. For example, a spare tire can be accommodated in the space 32. Since the bottom portion of the space 32 is configured by using the undercover portion 29 as described above, the structure of the vehicle lower part structure 50 is simpler than in the case where the space having the bottom portion is configured only by the rear floor portion that is configured separately from the undercover.

Further, the floor pan forming portion 27 includes a front wall portion (vertical wall portion) 27A that is a plate-like portion extending substantially vertically downward from the floor forming portion 23. Therefore, the floor pan forming portion 27 can be deeply formed so as to be connected to the undercover portion 29.

Further, in the vehicle lower part structure 50, the lower surface of the inclined portion 35 and the lower surface of the rear end of the undercover portion 29 are flush with each other. Therefore, when the vehicle 10 travels, the undercover portion 29 and the bumper cover 34 can provide good aerodynamic characteristics.

Although the vehicle lower part structure 50 according to the embodiment has been described above, these can be appropriately changed in design without departing from the gist of the present disclosure.

For example, as in the vehicle lower part structure 50A of the modification shown in FIG. 3, the rear edge portion 29A of the undercover portion 29 of the resinous unit 20A may be formed so as to be positioned one step upward as compared to the other portions. The front edge portion 35A of the inclined portion 35 of the bumper cover 34A may be located immediately below the rear edge portion 29A, and the portion located forward of the rear edge portion 29A of the lower surface of the undercover portion 29 and the lower surface of the inclined portion 35 may be located on the same plane. That is, the undercover portion 29 and the inclined portion 35 may be connected such that the portion located in front of the rear edge portion 29A of the lower surface of the undercover portion 29 and the lower surface of the inclined portion 35 are flush with each other. For example, the rear edge portion 29A and the front edge portion 35A may be fixed by the head portion 61 and the retaining portion 62 of the resin-made clip member 60 which form through holes communicating with each other in the rear edge portion 29A and the front edge portion 35A and vertically penetrate these through holes.

A rib (not shown) extending along the front-rear direction in a plan view may be provided on the lower surface of the undercover portion 29. In this way, the mechanical strength of the undercover portion 29 (resin unit 20, 20A) can be improved without deteriorating the aerodynamic performance of the undercover portion 29 (resin unit 20, 20A). Further, the bumper cover 34 and the lower surface of the inclined portion 35 of 34A may be provided with ribs (not shown) extending along the front-rear direction in a plan view. In this way, the mechanical strength of the bumper cover 34 and 34A (inclined portion 35) can be improved without deteriorating the aerodynamic performance of the bumper cover 34 and 34A (inclined portion 35).

What is claimed is:

1. A vehicle lower part structure, comprising:
a resin rear floor portion provided in a rear part of a vehicle and including a floor pan forming portion; and
a resin undercover portion that forms a lower surface of the rear part and that is molded integrally with the rear floor portion.

2. The vehicle lower part structure according to claim 1, wherein the floor pan forming portion includes a vertical wall portion that extends downward and whose lower end is connected to the undercover portion.

3. The vehicle lower part structure according to claim 1, further comprising:
a bumper cover that is provided in the rear part and whose front end is connected to a rear end of the undercover portion; and
a lower surface of the rear end of the undercover portion and a lower surface of the front end of the bumper cover are flush with each other.
